(19) United States
(12) Patent Application Publication
(10) Pub. No.: US 2011/0064842 A1
(43) Pub. Date: Mar. 17, 2011

(54) COOLING DEVICE FOR MOLDING APPARATUS

(75) Inventor: Hsiang-Hung CHEN, Tu-Cheng (TW)

(73) Assignee: HON HAI PRECISION INDUSTRY CO., LTD., Tu-Cheng (TW)

(21) Appl. No.: 12/749,474

(22) Filed: Mar. 29, 2010

(30) Foreign Application Priority Data
Sep. 16, 2009 (CN) 200910307088.0

(51) Int. Cl. B29C 45/73

(52) U.S. Cl. 425/552

(57) ABSTRACT

A cooling device includes a housing and a die. The housing includes a top, a bottom, and a plurality of sidewalls interconnecting the bottom and the top. Two opposite sidewalls of the housing respectively defines a plurality of first inlets and outlets. The die is received in the housing and defines a plurality of first passages spanning opposite side surfaces, and the first passages are aligned with the first inlets and the outlets of the housing. A second passage is defined between the die and the sidewalls of the housing. The first and second passages are configured for conducting the cooling fluid to cool the die.

### BACKGROUND

1. Technical Field

The disclosure relates to cooling devices for molding apparatuses.

2. Description of Related Art

Generally, for molding thermoplastic using a thermoforming machine, such as an injection-molding machine or apparatus, the following steps are carried out. First, the thermoplastic to be molded is supplied to a thermoforming machine; the thermoplastic to be plasticized, is heated in a cylindric chamber in the machine, and then the melted plastic is injected into a die from a nozzle. Finally, the molded plastic inside the die is cooled by the conducting of cooling fluid into a plurality of conduits formed in the die. The cooling device employed in the thermoforming machine is ineffective to cool the die effectively and uniformly because of all of the surfaces of the die which are away from the conduits and which mostly cannot be cooled by the fluid inside the conduits.

Therefore it is desirable to provide a cooling device which can cool the molding apparatus more effectively and uniformly.

### BRIEF DESCRIPTION OF THE DRAWINGS

FIG. 1 is an exploded isometric view of a cooling device in accordance with an embodiment.

FIG. 2 is an isometric view of the cooling device of FIG. 1 in use.

### DETAILED DESCRIPTION

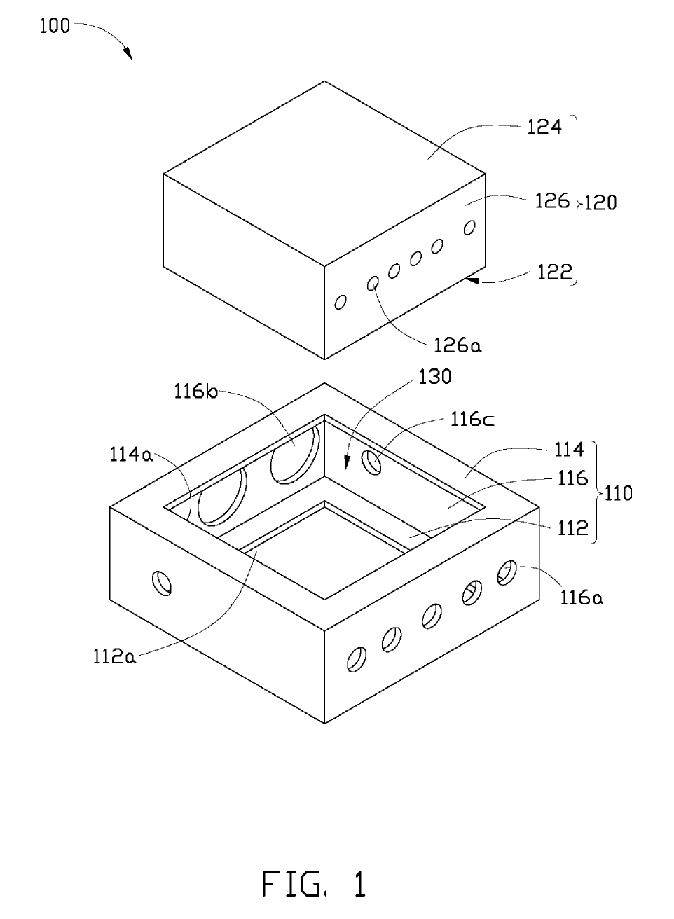

Referring to FIG. 1, a cooling device 100 for cooling a molding apparatus is shown. The cooling device 100 includes a housing 110 and a die 120 received in the housing 110.

The housing 110 is shaped corresponding to the shape and profile of the die 120, and includes a bottom 112, a top 114 and a plurality of sidewalls 116 interconnecting the bottom 112 and the top 114. The bottom 112 defines a first opening 112a through which the die 120 is exposed. The length and the width of the first opening 112a are shorter than the respective counterparts of the corresponding sides of the die 120, and are sealed by the die 120 from the inner side of the bottom 112. The top 114 defines a second opening 114a therein corresponding to the first opening 112a. The second opening 114a serves as the entrance for inserting the die 120 into the housing 110. One of the sidewalls 116 defines a number of first inlets 116a for the passage of water into the housing 110. Two outlets 116b are defined in another sidewall 116 which is opposite to the first inlets 116a. Each of the other two sidewalls 116 defines a second inlet 116c adjacent to the outlets 116b but away from the first inlet 116a. The first and second inlets 116a and 116c are smaller than the outlets 116b, respectively.

The die 120 includes a fixing surface 122, an opposite parting surface 124 and a number of side surfaces 126 interconnecting with the fixing surface 122 and the parting surface 124. The die 120 is mounted with the fixing surface 122 on the bottom 112 of the housing 110 to seal the first opening 112a. The parting surface 124 is exposed from the second opening 114a and is capable of matching with another die 120 to form a die cavity in which the plasticized plastic is shaped to a predefined shape or profile. Because the assembly tolerance and the manufacturing tolerance of the housing 110 and the die 120 do exist, some interstices (not shown) may get between the side surface 126 of the die 120 and the sides surrounding the second opening 114a. The interstices can be filled and sealed by a waterproof material. A number of first passages 126a are formed in the die 120, each of the first passages 126a spanning two opposite side surfaces 126 of the die 120. One end of each first passage 126a is aligned with one of the first inlets 116a, and the other end of the first passage 126a is aligned with one of the outlets 116b. A second passage 130 is defined between the side surface 126 of the die 120 and the sidewalls 116 of the housing 110.

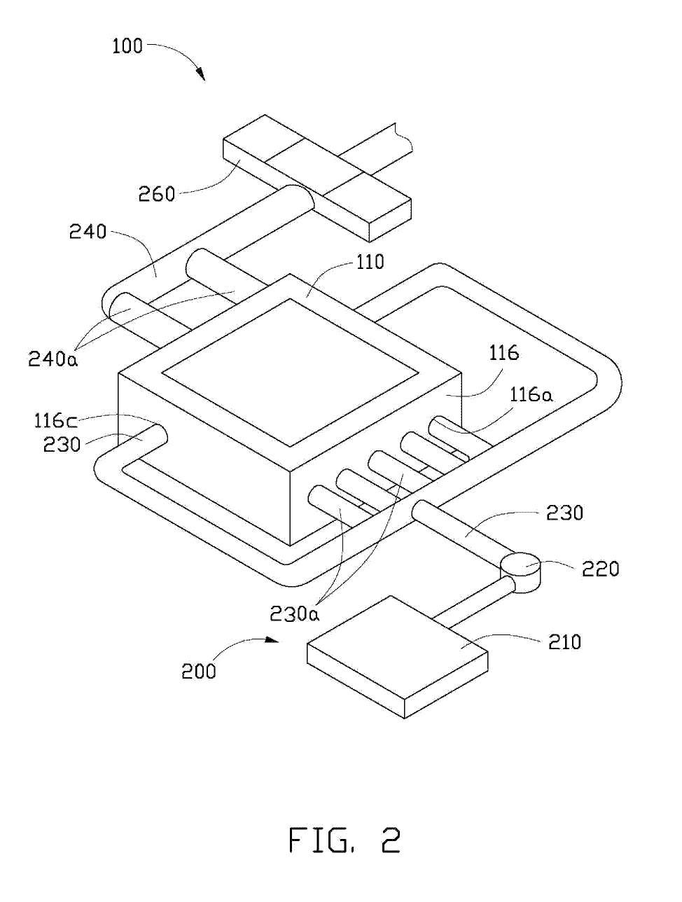

Referring to FIG. 2, the cooling device 100 is used accompanying a cooling control system 200. The cooling control system 200 includes a container 210, a pump 220, an inlet pipe 230, an outlet pipe 240, and a valve 260.

The container 210 is used for storing the cooling fluid, and is communicated to the inlet of the pump 220 by a tube (not labeled). The output of the pump 220 is communicated to the first inlet 116a of the housing 110 by the inlet pipe 230. The inlet pipe 230 includes a number of branched outlets 230a, which are connected to the housing 110 and correspondingly aligned with the first inlets 116a and the second inlets 116c. The outlet pipe 240 includes a number of branched inlets 240a, which are connected to the housing 110 and aligned with the outlets 116b. The valve 260 is connected to the outlet pipe 240.

In use, the cooling fluid is drawn from the container 210 by the pump 220, and then pumped into the housing 110 through the inlet pipe 230 and the first and second inlets 116a and 116c. The cooling fluid in the housing 110 simultaneously flows through the first passage 126a of the die 120 and the second passage 130 between the side surface 126 and the sidewalls of the housing 110, thereby cooling the die 120 from the inside and outside. As such, the cooling of the die 120 is improved in various aspects, such as improving cooling efficiency and shortening the cooling time. In addition, the second inlets 116c are adjacent to the outlets 116b but away from the first inlets 116a, which thereby effectively reduces the temperature differences between two opposite ends of the die 120 respectively facing the first inlets 116a and the outlets 116b, and improves the cooling uniformity of the die 120.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A cooling device comprising:
a housing comprising a top, a bottom, and a plurality of sidewalls interconnecting the bottom and the top, wherein two opposite sidewalls of the housing respectively defines a plurality of first inlets and outlets therein; and
a die received in the housing and defining a plurality of first passages spanning opposite side surfaces of the die, and the first passages are aligned with the first inlets and the outlets of the housing;
wherein, a second passage is defined between the die and the sidewalls of the housing, and the first passages and the second passage are configured for conducting cooling fluid to cool the die.

2. The cooling device of claim 1, wherein at least two second inlets are respectively formed in other sidewalls of the housing.

3. The cooling device of claim 2, wherein the second inlets are adjacent to the outlets but away from the first inlets.

4. The cooling device of claim 3, wherein the diameters of the first and second inlets are smaller than the diameters of the outlets, respectively.

5. The cooling device of claim 2, wherein the bottom of the housing defines a first opening therein; the die is mounted on the bottom of the housing and seals the first opening.

6. The cooling device of claim 5, wherein the top of the housing defines a second opening as an entrance for the die into the housing, the second opening is sealed by the die and a waterproof material is filled in the interstice between the die and the open side of the second opening.

7. The cooling device of claim 6, wherein the die comprises a fixing surface, an opposite parting surface and a plurality of side surfaces interconnecting the fixing surface and the parting surface; the die is mounted on the bottom of the housing by the fixing surface; the parting surface is exposed from the second opening.

8. A cooling control system configured for the cooling device of claim 6, the cooling control system comprising:
a container filled with the cooling fluid;
a pump communicated to the container by a tube;
an inlet pipe communicating the pump to the housing, and the inlet pipe comprising a plurality of branched outlets aligned with the first and second inlets;
an outlet pipe comprising a plurality of branched inlets connected to the housing and aligned with the outlets; and
a valve connected to the outlet pipe.
